(19) United States
(12) Patent Application Publication
(10) Pub. No.: US 2013/0042513 A1
(43) Pub. Date: Feb. 21, 2013

(54) PAINTBALL BARREL TAG

(71) Applicant: Keith SZWAST, Chicago, IL (US)

(72) Inventor: Keith SZWAST, Chicago, IL (US)

(21) Appl. No.: 13/589,305

(22) Filed: Aug. 20, 2012

Related U.S. Application Data
(60) Provisional application No. 61/525,243, filed on Aug. 19, 2011.

(51) Int. Cl. G09F 3/14; F41B 11/00

(52) U.S. Cl. 40/673

(57) ABSTRACT

An apparatus for identifying members of a paintball team and/or a special group. The apparatus including a stretchable loop that frictionally engages a gun barrel and a colored strip that hangs from the stretchable loop to identify the team and/or special group.

### CROSS REFERENCE TO RELATED APPLICATION

This application claims priority to and the benefit of U.S. Provisional Patent Application Ser. No. 61/525,243, filed on 19 Aug. 2011. The provisional application is hereby incorporated by reference herein in its entirety and is made a part hereof, including but not limited to those portions which specifically appear hereinafter

### BACKGROUND OF THE INVENTION

1. Field of the Invention

This invention is directed to an apparatus for identifying members of a team during a paintball game or members of a group. More specifically, this invention is directed to a barrel tag for a gun, such as a paintball gun and a handgun.

2. Discussion of Related Art

Over the last thirty years, the game of paintball has exploded in popularity. During this time, a number of variations of the game have been developed, including capture the flag, traitor and elimination. Most of these games require players to be divided into at least two teams.

Uniforms have been used to divide up players into teams. However, dividing teams by uniforms require participants to prepare and divide team before arriving at a paintball field. Further, with uniforms, the players cannot easily change teams once the game has begun.

Colored arm bands have also been used to divide up players into teams. Colored arm bands are often preferred over uniforms because they do not require preparation and allow for “pick-up” games. Further, colored arm bands also allow players to easily change teams. However, colored arm bands have a number of short comings. Colored arm bands can be easily hidden from view by tucking an arm down or behind the player's back making it difficult for other players to determine if the player is a teammate or an opponent. Colored arm bands can also easily fall off a player's arm, making it impossible to determine if a player is a teammate or opponent. Further, colored arm bands must be tied on or fastened to an arm by another player.

Accordingly, there is a need for a device for dividing paintball players into teams that do not have the short comings of known devices.

### SUMMARY OF THE INVENTION

A general object of the invention is to provide a device for identifying teams during a paintball game and/or members of a special group.

The general object of the invention can be attained, at least in part, through a barrel tag connected to a stretchable loop. The barrel tag is preferably a colored strip of a durable material, such as a rectangular-shaped strip of weaved nylon. Alternatively, the colored strip may constructed of any material including, but not limited to, a plastic material, a rubber material, a cloth material, and a metal. In a preferred embodiment, the colored strip is a bright easily visible color such as, but not limited to, bright neon yellow or orange. Alternatively, the colored strip is a reflective material that will stand out against a background.

The stretchable loop is preferably a durable and stretchable material which can be repeatedly stretched to be applied to and removed from a barrel of a gun. In a preferred embodiment, the stretchable loop comprises a rubber material which can be stretched and applied to the barrel of a paintball gun. The rubber material engages the barrel with friction to prevent the barrel tag from slipping off during competition. In a preferred embodiment, the stretchable loop comprises an annular shape with a diameter slightly smaller than an external diameter of the barrel of the paintball gun. With this arrangement, the stretchable loop must be stretched to fit around the barrel, thereby stretchingly engaging the paintball barrel, preventing the barrel tag from slipping off the barrel.

In an alternative embodiment, the barrel tag is designed to be attached to another part of the paintball gun, such as, but not limited to, a hopper, a grip, a stock, a trigger guard and a CO₂ canister.

### BRIEF DESCRIPTION OF THE DRAWINGS

These and other objects and features of this invention will be better understood from the following detailed description taken in conjunction with the drawings, wherein:

FIG. 1 is a side view of a barrel tag according to an embodiment of this invention;

FIG. 2 is a side view of the barrel tag of FIG. 1 on a paintball gun; and

FIG. 3 is a side view of a barrel tag according to an embodiment of this invention on a firearm.

### DESCRIPTION OF PREFERRED EMBODIMENTS

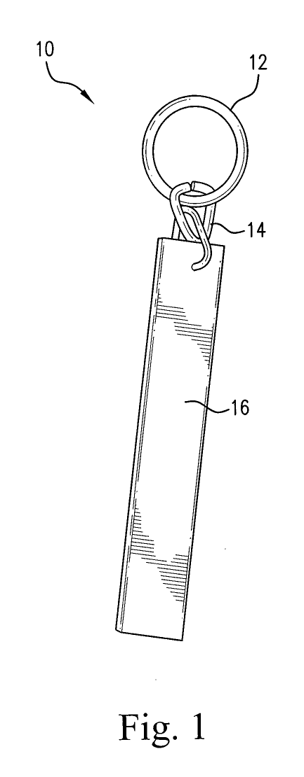

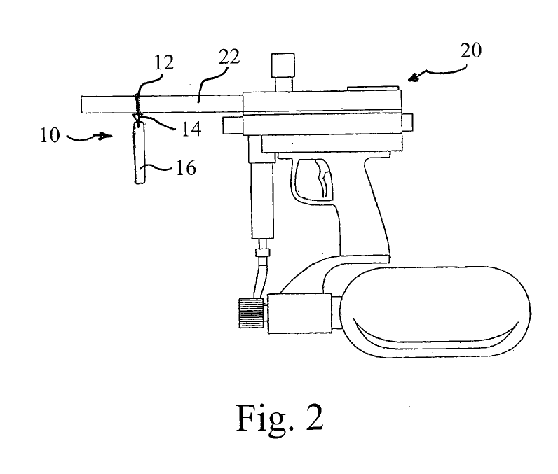

FIG. 1 shows a barrel tag 10 according to one embodiment of this invention. In this embodiment, the barrel tag 10 includes a stretchable loop 12 connected to a link 14 and the link 14 connected to a colored strip 16. FIG. 2 shows the barrel tag 10 positioned on a paintball gun 20.

In a preferred embodiment, the stretchable loop 12 comprises a durable and stretchable material which can be repeatedly stretched to be applied to and removed from a barrel 22 of the paintball gun 20. In a preferred embodiment, the elastic loop 12 is constructed from a rubber material, however, the elastic loop may be constructed of any material capable of being stretched and applied to the barrel 22 of the paintball gun 20, including for example a rubber, an elastomer, a plastic or a polymer material. In a preferred embodiment, the stretchable loop 12 frictionally engages the barrel 22 to prevent the barrel tag 10 from slipping off during competition. In this embodiment, the stretchable loop 12 comprises an annular shape with a diameter slightly smaller than an external diameter of the barrel 22 of the paintball gun 20. With this arrangement, the stretchable loop 12 must be stretched to fit around the barrel 22, thereby stretchingly engaging the paintball barrel 22, preventing the barrel tag 10 from slipping off the barrel 22. In the embodiment of FIG. 1, the stretchable loop 12 comprises an inner diameter of 2.2 cm (0.87 inches) and an outer diameter of 2.54 cm (1.0 inches), however the stretchable loop 12 may comprise any dimensions. In an alternative embodiment of this invention, the paintball barrel 22 includes a ridge or notch and the stretchable loop 12 may be positioned adjacent to the ridge or notch to look the stretchable loop in position and to prevent the stretchable loop 12 from moving along the paintball barrel 22 and slipping off the paintball barrel 22. In another alternative embodiment, the barrel tag 10 may not include the stretchable loop and instead may comprise straps for tying the barrel tag 10 to the barrel 22 or a clamp or clip for joining the barrel tag 10 to the barrel 22.

In FIG. 1, the colored strip 16 is joined to the stretchable loop 12 with the link 14. In this embodiment, the link 14 comprises a pair of links, however, the link 14 may comprises any number of links or a single link. In this embodiment, the links 14 are triangular-shaped links that are made of metal. Metal provides a strong and durable connection. However, the link 14 may be made of other materials including, but not limited to, plastic, rubber, cloth and polymer materials. In an alternative embodiment, the link 14 may be constructed with a swivel connector, or a similar connector, that prevents the barrel tag 10 from becoming tangled during competition. In another embodiment, the barrel tag 10 may be constructed without the link and the stretchable loop 12 may be connected directly to the colored strip 16.

In the preferred embodiment of FIG. 1, the colored strip 16 is made of a weaved nylon material that is very durable and capable of repeated use, even in rainy, cold, muddy, and hot conditions. Alternatively, the colored strip 16 may be made of another material that can be replaced easily, for example, a plastic material, a rubber material and a cloth material. In a preferred embodiment, the colored strip 16 is a bright and easily visible color such as, bright neon yellow and orange. However, the colored strip is not limited to these colors and may comprise any color or colors. In an alternative embodiment, the colored strip 16 is a reflective material that will stand out against a background, such as a forest background or a desert background. In another alternative embodiment, the colored strip 16 includes a logo, a namer and/or another type of indicator of a team. In another embodiment, the colored strip 16 may include a light source to allow for twilight or nighttime gameplay.

As shown in FIG. 2, the barrel tag 10 of this invention can be attached to the barrel 22 of the paintball gun 20. In an alternative embodiment, the barrel tag 10 of this invention may be designed to be attached to another part of the paintball gun 20, such as, but not limited to, a hopper, a grip, a stock, a trigger guard and a CO₂ canister.

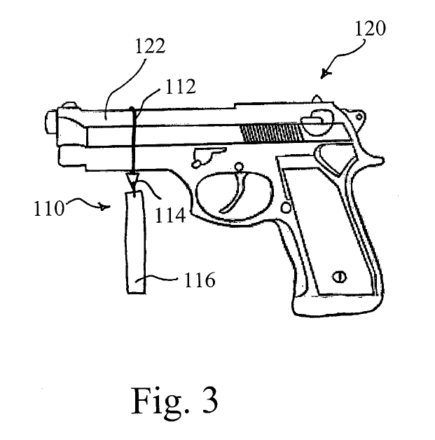

In an alternative embodiment of this invention, as shown in FIG. 3, a tag 110 may be connected to a firearm 120 rather than a paintball gun. Recently there has been a growing movement to enact concealed carry laws to protect citizens against the increase in violent crime and random shootings. However, many individuals have concerns that concealed carry laws will result in a greater loss of innocent lives as a result of additional shooters along with the confusion of innocent people and responding police during extremely high stress situations. The tag 110 of this invention could help minimize confusion by clearly visually identifying individuals who have completed the necessary steps to receive a concealed carry permit. This would allow innocent people to easily identify persons to seek protection from and to allow police to distinguish persons having concealed carry permits from a person trying to cause harm. Such identification/permit tags 110 could be issued by a government agency, such as state police, and subject to stringent requirements. As shown in FIG. 3, the tag 110 of this embodiment preferably includes a connector 112 that can be preferably permanently connected to a barrel 122 of the firearm 120, a link 114 connected to the connector 112 and a colored strip 116 connected to the link 114. The connector 112 may comprise, for example but not limited to, a weld connection, a screw, a stretchable loop and a clamp. In an alternative embodiment, the tag 110 of this invention may be designed to be attached to another part of the firearm 120, such as, but not limited to, a trigger guard, a grip, a stock, and a magazine. In a preferred embodiment, the tags 110 for the firearm 120 may include a unique identifier tying a gun to a permit and a tamper evident and/or resistant feature to prevent removal of the tag from the gun associated with the permit. In an alternative embodiment, the tag 10 may include a tracking device, such as a GPS device, to allow police to identify the number of persons with a concealed gun permit in an area from a remote location.

Thus, this invention provides a device for distinguishing player of one paintball team from another and members of a special group. Because the barrel tag is positioned on a gun barrel, it cannot be easily concealed or hidden from view. Other players and observers can easily see the barrel tag from nearly all sides including the front, left, right, the rear-left side and the rear-right side of the person.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. An apparatus for identifying members of a paintball team comprising:
a paintball gun with a barrel having an outer diameter;
an stretchable loop comprising an inner diameter with a dimension smaller than the outer diameter of the paintball gun;
a colored strip connected to the stretchable loop; and
wherein the stretchable loop is positioned on the barrel of the paintball gun.

2. The apparatus of claim 1 further comprising:
a link connecting the stretchable loop and the colored strip.

3. The apparatus of claim 2, wherein the link comprises a swivel connection.

4. The apparatus of claim 1, wherein the stretchable loop comprises an elastomer.

5. The apparatus of claim 1, wherein the colored strip comprises a weaved nylon material.

6. An apparatus for identifying members of a paintball team comprising:
a paintball gun with a barrel, the barrel including a surface with at least one of a ridge and a notch;
an stretchable loop positioned on the barrel, the stretchable loop comprising dimensions to engage the at least one of the ridge and the notch to prevent movement of the stretchable loop along the barrel of the paintball gun; and
a colored strip connected to the stretchable loop.

7. The apparatus of claim 6 further comprising:
a link connecting the stretchable loop and the colored strip.

8. The apparatus of claim 7, wherein the link comprises a swivel connection.

9. The apparatus of claim 6, wherein the stretchable loop comprises an elastomer.

10. The apparatus of claim 6, wherein the colored strip comprises a weaved nylon material.

11. An apparatus for identifying members of a group comprising:
A connector permanently connected to a part of a gun, wherein the part of the gun includes one of a barrel, a grip, a stock and a trigger guard; and
a colored strip connected to the connector, wherein the colored strip hangs from the gun to indicate an affiliation.

12. The apparatus of claim 11 further comprising:
a link connecting the connector and the colored strip.

13. The apparatus of claim 12, wherein the link comprises a swivel connection.

14. The apparatus of claim 11, wherein the colored strip comprises a weaved nylon material.

15. The apparatus of claim 11, wherein the colored strip includes a GPS device.

16. The apparatus of claim 11, wherein the connector includes at least one of a tamper evident device and a tamper resistant device to prevent removal of the barrel tag from the gun.
